(19) United States
(12) Patent Application Publication
(10) Pub. No.: US 2026/0069488 A1
(43) Pub. Date: Mar. 12, 2026

(54) MASSAGE CORE MECHANISMS AND MASSAGE APPARATUS

(71) Applicant: XIAMEN COMFIER TECHNOLOGY CO., LTD., Fujian (CN)

(72) Inventors: Jianqing LI, Fujian (CN); Zhicheng ZHANG, Fujian (CN); Guoyan OU, Fujian (CN)

(21) Appl. No.: 19/382,229

(22) Filed: Nov. 6, 2025

(30) Foreign Application Priority Data
Sep. 10, 2024 (CN) 202422209585X

(51) Int. Cl. A61H 7/00; A61H 15/00

(52) U.S. Cl. CPC A61H 7/007; A61H 2015/0014; A61H 2201/0142; A61H 2201/149; A61H 2201/1623; A61H 2201/1678; A61H 2201/5066; A61H 2201/5092; A61H 2205/04

(57) ABSTRACT

A massage core mechanism having a housing, a drive device, and a massage assembly that includes two massage arms. A massage head assembly is detachably connected to and positioned between front ends of the two massage arms. The two massage arms perform reciprocating motion when rear ends of the two massage arms are driven by the drive device. The massage head assembly has a connecting rod and at least one massage member connected thereto; the front ends of the two massage arms have connection slots respectively into which the connecting rod is embedded and fixed. A massage apparatus having the above massage core mechanism is also provided. The massage head assembly can be easily replaced and repaired.

### TECHNICAL FIELD

The present invention relates to the technical field of massage equipment, and more particularly to massage core mechanisms and a massage apparatus.

### BACKGROUND OF THE INVENTION

With the improvement of living standards and the fast pace of life, people tend to use massage devices for stress relief and fatigue alleviation. There are many types of health-care massage devices in the market. Among them, massage cushions, massage beds, and massage chairs enable a user to relax in a reclining or lying posture, and can simultaneously massage the user's shoulder-neck area and lumbar area, thus providing comfort to the user and being multi-functional. However, massage cushions, massage beds, and massage chairs in the prior art generally have relatively complex structures. The massage head assembly in the massage core mechanism is fixedly installed at the factory and cannot be easily detached. After purchase, the user can only use the massage head assembly installed by the manufacturer. If the massage head assembly does not suit the user's physical condition, the user cannot replace it; or, when the massage head assembly is damaged, disassembling and then reassembling the massage head assembly during maintenance are relatively cumbersome, resulting in high maintenance costs. Therefore, existing massage beds and massage chairs still cannot fully meet individual needs in the market.

In addition, a massage core mechanism in the prior art is typically used in a massage apparatus (such as a massage cushion, massage chair, or massage bed) to travel up and down reciprocally to massage the user's neck, back, and waist. The massage functions in a massage apparatus are increasingly abundant. In a massage apparatus having a kneading function, the massage members travelling up and down reciprocally can perform kneading and rolling massages on the entire back (including lower waist area), wherein in such kneading mode, the massage members do not perform swinging or opening/closing movements but instead apply pressure to the back solely by traveling up and down. However, in a massage core mechanism of the prior art, operating modes of a massage assembly are preset, a distance of the massage members (which contacts the human body and are typically designed as massage heads) with respect to a surface of the massage apparatus in contact with the user is constant, and the resulting massage force is constant and unadjustable, leading to unvariable massage intensity. Additionally, due to the natural physiological curvature of the human back, when the distance of the massage members (massage heads) with respect to the surface of the massage apparatus in contact with the user remains unchanged during massage, the pressure applied to the back and waist will vary significantly as the massage members travel up and down (e.g., weaker around the waist since the waist is usually positioned more away from the massage apparatus, and stronger around the back since the back is usually positioned more proximal to and prone to press against the massage apparatus). As a result, a user, while sitting on a massage apparatus, would need to intentionally lean closer to or away from the backrest of the massage apparatus to try to balance the pressure on the back and waist; when lying on the massage apparatus, the user would feel uneven massage intensity over the back and waist. Such massage is inadequate and uncomfortable, thereby adversely affecting user's experience.

### BRIEF SUMMARY OF THE INVENTION

Objects of the present invention are to provide massage core mechanisms and a massage apparatus, which allow convenient replacement or maintenance of the massage head assembly, enhance comfort, provide good universality, and reduce maintenance costs.

To achieve the above objects, the present invention adopts the following technical solutions:

A first massage core mechanism, comprising a housing, a first drive device, and a massage assembly; the massage assembly comprises two massage arms parallel to each other; a massage head assembly is detachably connected to and positioned between front ends of the two massage arms; rear ends of the two massage arms are mounted on the first drive device; the two massage arms are configured to perform reciprocating motion when the rear ends of the two massage arms are driven by the first drive device; the massage head assembly comprises a connecting rod and at least one massage member connected to the connecting rod; the front ends of the two massage arms are provided with connection slots respectively; when the massage head assembly is connected to the two massage arms, two ends of the connecting rod are embedded and fixed in the connection slots respectively.

Further, a connection section is provided at each of the two ends of the connecting rod; an annular recess recessed circumferentially around the connecting rod is formed in each connection section; each of the connection slots has an opening that opens at an upper side thereof; a rib ridge protrudes upwardly from a bottom surface of each of the connection slots; when the connection section of each of the two ends of the connecting rod is inserted into a corresponding connection slot, the annular recess of the connection section receives the rib ridge of the corresponding connection slot.

Further, each of the connection slots is a U-shaped slot that has the opening that opens upwardly at the upper side thereof, and each of the connection slots has a shape that matches a shape of a corresponding connection section of the connecting rod.

Further, said at least one massage member of the massage head assembly comprises two symmetric massage members connected to the connecting rod; each of the two symmetric massage member is located on the connecting rod at a position facing to an inner end of a corresponding connection section, wherein the inner end of the corresponding connection section is defined as an end of the corresponding connection section which is more proximal to a middle point of a length of the connection rod than another opposite end of the corresponding connection section; protrusions are also formed on the two ends of the connecting rod respectively, wherein each of the protrusions is located on a corresponding one of the two ends of the connecting rod at a position on the connecting rod between the annular recess on the corresponding one of the two ends of the connecting rod and a corresponding one of the two symmetric massage members on the corresponding one of the two ends of the connecting rod; when the connection section at each of the two ends of the connecting rod fits into a corresponding connection slot, each of the protrusions is limited within the opening of the corresponding connection slot.

Further, at least one of the connection slots of a corresponding one of the two massage arms is provided with a first sensor configured to sense the massage head assembly; the first sensor generates a first sensing signal to signify presence of the massage head assembly when the connecting rod is connected to said at least one of the connection slots.

Further, the first drive device comprises a first massage motor, a first transmission gear set driven by the first massage motor, a rotating shaft driven to be rotated by the first transmission gear set, and two eccentric wheels connected on two ends of the first rotating shaft respectively; the rear ends of the two massage arms sleeve the two eccentric wheels respectively.

A massage apparatus, comprising a back plate; the first massage core mechanism is mounted on the back plate; a traveling mechanism that allows the first massage core mechanism to be movable thereon is provided on the back plate; the traveling mechanism comprises a rack disposed on the back plate; the first massage core mechanism further comprises a second drive device for driving the first massage core mechanism to travel reciprocally on the traveling mechanism.

Further, a placement slot is also provided on the back plate, and a flip cover is provided to open and close the placement slot; the placement slot is configured to accommodate a plurality of spare massage head assemblies each being the massage head assembly as defined above; massage members of the plurality of spare massage head assemblies are in different shapes; each of all the plurality of spare massage head assemblies is capable of being detachably connected to and positioned between the front ends of the two massage arms.

Further, a first Hall sensor is provided on the back plate on one side of the placement slot; a first magnet corresponding to the first Hall sensor is mounted on a rear surface of the flip cover facing the placement slot for sensing the first Hall sensor when the flip cover closes the placement slot.

Further, the second drive device comprises a first traveling motor, a first traveling transmission gear set driven by the first traveling motor, and a first traveling gear meshed with the rack so that the first massage core mechanism is driven to move on the rack along the back plate.

Further, the first drive device comprises a first massage motor, a first transmission gear set driven by the first massage motor, a rotating shaft driven to be rotated by the first transmission gear set, and two eccentric wheels connected on two ends of the first rotating shaft respectively; the rear ends of the two massage arms sleeve the two eccentric wheels respectively; the first transmission gear set comprises a first worm wheel; a worm wheel sensor is provided at an outer side of the first worm wheel; a plurality of worm wheel sensing elements are arranged on the first worm wheel along a circumferential direction thereof; when the first worm wheel rotates, the worm wheel sensor detects the plurality of worm wheel sensing elements and generates a second sensing signal; a eccentric wheel sensing element is provided on one of the two eccentric wheels, and a eccentric wheel sensor is provided on one side of said one of the two eccentric wheels; the eccentric wheel sensor detects the eccentric wheel sensing element and outputs a third sensing signal when said one of the two eccentric wheels drives a corresponding one of the two massage arms to oscillate to a lowest point; a traveling gear sensor is provided on an outer side of the first traveling gear; a plurality of traveling gear sensing elements are arranged on the first traveling gear along a circumferential direction thereof; when the first traveling gear rotates, the traveling gear sensor detects the plurality of traveling gear sensing elements and generates a fourth sensing signal.

Further, the worm wheel sensor, the eccentric wheel sensor, and the traveling gear sensor are grating sensors, and the plurality of worm wheel sensing elements, the eccentric wheel sensing element, and the plurality of traveling gear sensing elements define grating detection points.

Further, the back plate is curved to conform to a curvature of a human back; the rack is also curved to follow a curved shape of the back plate; the rack comprises, from top to bottom, a starting section corresponding to a neck, a middle section corresponding to a back, and an outward convex arc section corresponding to a waist.

Further, a second massage core mechanism is further provided on the back plate capable of travelling reciprocally on the traveling mechanism.

Further, the second massage core mechanism comprises a third drive device, a second massage head assembly, and a fourth drive device; the third drive device comprises a second massage motor, and a second transmission gear set driven by the second massage motor; the fourth drive device comprises a second traveling motor, and a second traveling transmission gear set driven by the second traveling motor; the second traveling transmission gear set is provided with a second traveling gear meshed with the rack, so that the second massage core mechanism is capable to move on the rack along the back plate; a lower-limit travel switch is further provided on the back plate to limit downward movement of the second massage core mechanism.

Further, the second traveling transmission gear set is also provided with a transmission gear driving the second traveling gear to rotate; a transmission gear sensor is provided on an outer side of the transmission gear; a plurality of transmission gear sensing elements are circumferentially arranged on a bottom surface of the transmission gear; when the second traveling gear rotates, the transmission gear sensor detects the plurality of transmission gear sensing elements and generates a fifth sensing signal.

Further, the second transmission gear set comprises two kneading transmission gears; kneading gears are connected to the two kneading transmission gears respectively; neck massage heads are eccentrically provided on the kneading gears respectively; a anti-clamping Hall sensor is provided on an outer side of one of the kneading gears; a kneading gear magnet is provided on said one of the kneading gears; when the neck massage head on said one of the kneading gears rotates to an outer side, the kneading gear magnet is sensed by the anti-clamping Hall sensor.

By adopting the technical solutions described herein, the present invention provides at least the following advantages:

1. The massage head assembly is detachably connected to the two massage arms. When a massage head assembly does not suit a user, it can be removed and replaced with another massage head assembly to improve comfort.

2. When a massage head assembly is damaged and needs repair or replacement, only the damaged massage head assembly needs to be removed for repair or replacement, without having to repair or replace the entire massage assembly, thereby reducing maintenance difficulty and cost.

3. In a kneading mode when the first massage core mechanism is installed in a massage apparatus and travels along the massage apparatus to perform, a peak height of the massage member of the massage head assembly can be adjusted; moreover, during travelling of the first massage core mechanism, the peak height of the massage member can be automatically adjusted in a timely manner when the first massage core mechanism travels to different regions, thereby better conforming to the curvature of human back for massage and achieving a more comfortable massage experience.

### BRIEF DESCRIPTION OF THE DRAWINGS

FIG. 1 is a front view of the massage apparatus of the present invention.

FIG. 2 is a perspective structural view of the first massage core mechanism of the present invention.

FIG. 3 is an exploded view of the first massage core mechanism of the present invention.

FIG. 4 is a structural view of one massage arm.

FIG. 5 is a schematic view of one massage head assembly.

FIG. 6 is a schematic view of another massage head assembly.

FIG. 7 is a schematic view of the massage apparatus of the present invention (showing the placement slot).

FIG. 8 is a schematic view showing motion transmission structure between the first massage core mechanism and the traveling mechanism of the present invention.

FIG. 9 is a front view of another embodiment of the massage apparatus of the present invention.

FIG. 10 is a side sectional view of the massage apparatus of FIG. 9 (showing the rack being curved).

FIG. 11 is a perspective structural view of another embodiment of the first massage core mechanism (showing a traveling gear sensor).

FIG. 12 is a perspective structural view of another embodiment of the first massage core mechanism (showing a eccentric wheel sensor).

FIG. 13 is a rear perspective structural view of another embodiment of the first massage core mechanism (showing a worm wheel sensor).

FIG. 14 is a structural schematic view of a second massage core mechanism of the present invention.

FIG. 15 is a schematic view of a transmission gear structure in the second massage core mechanism (showing a bottom surface of the transmission gear).

FIG. 16 is a structural view of a lower-limit travel switch according to the present invention.

FIG. 17 is a partially exploded view of the lower-limit travel switch of FIG. 16, wherein a metal contact piece and a front end of a lower spring switch within or under a trigger block is indicated in broken lines.

### REFERENCE NUMERALS

1 first massage core mechanism;
11 housing; 111 upper housing; 112 lower housing;
12 massage assembly; 121 massage arm; a connection section; 122 connection slot; 1221 rib ridge; 123 first sensor;
13 massage head assembly; 131 connecting rod; 1311 annular recess; 132 massage member; 133 protrusion;
14 second drive device; 141 first traveling motor; 142 first traveling transmission gear set; 143 first traveling gear; 1431 traveling gear sensing element;
15 first drive device; 151 first massage motor; 152 first transmission gear set; 1521 worm wheel; 1522 worm wheel sensing element; 153 first rotating shaft; 154 eccentric wheel; 1541 eccentric wheel sensing element;
16 traveling mechanism; 161 rack; 1611 starting section; 1612 middle section; 1613 outward convex arc section;
2 massage apparatus; 20 back plate; 21 placement slot; 22 flip cover; 221 first magnet; 23 lower-limit travel switch; 231 spring switch; 2311 spring; 232 metal contact piece; 233 trigger block; 234 limiting block; 24 first Hall sensor;
3 second massage core mechanism; 31 third drive device; 311 second massage motor; 312 second transmission gear set; 3121 kneading transmission gear; 3122 kneading gear; 3123 kneading gear magnet; 32 second massage head assembly; 321 neck massage head; 33 fourth drive device; 331 second traveling motor; 332 second traveling transmission gear set; 3321 second traveling gear; 3322 transmission gear; 3323 transmission gear sensing element;
41 worm wheel sensor; 42 eccentric wheel sensor; 43 traveling gear sensor; 44 transmission gear sensor; 45 anti-clamping Hall sensor.

### DETAILED DESCRIPTION OF THE INVENTION

To further explain the technical solutions of the present invention, specific embodiments are described in detail below.

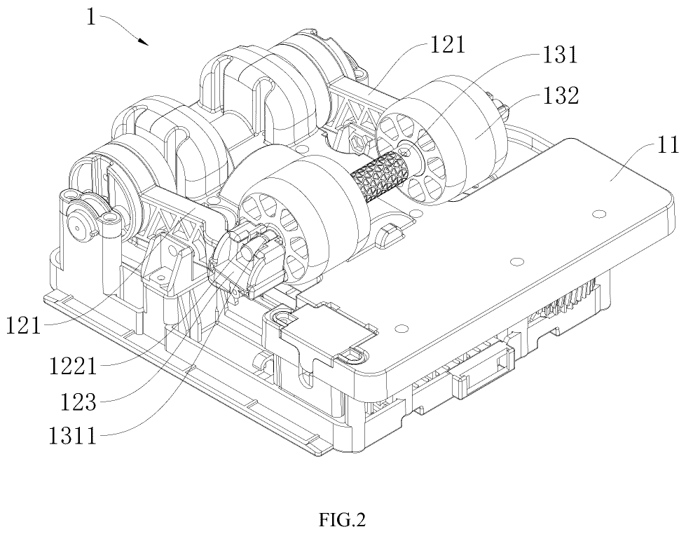

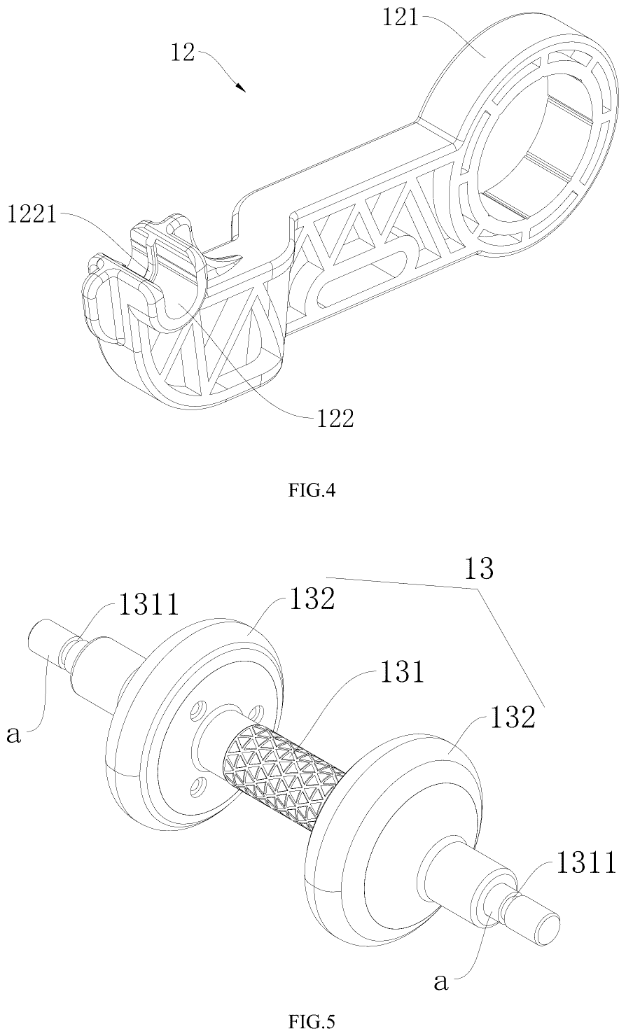

With reference to FIGS. 2 to 5, the present invention discloses a first massage core mechanism 1, comprising a housing 11, a first drive device 15, and a massage assembly 12. The massage assembly 12 comprises two massage arms 121 parallel to each other; a massage head assembly 13 is detachably connected to and positioned between front ends of the two massage arms 121. Rear ends of the two massage arms 121 are mounted on the first drive device 15; the two massage arms 121 are configured to perform reciprocating motion when the rear ends of the two massage arms 121 are driven by the first drive device 15, thereby driving the massage head assembly 13 on the two massage arms 121 to perform reciprocating kneading movements. The massage head assembly 13 comprises a connecting rod 131 and at least one massage member 132 connected to the connecting rod 131. The front ends of the two massage arms 121 are provided with connection slots 122 respectively. When the massage head assembly 13 is connected to the two massage arms 121, two ends of the connecting rod 131 are embedded and fixed in the connection slots 122 respectively by interference-fit, so as to realize detachable connection of the massage head assembly 13 to the two massage arms 121.

Specifically, a connection section a is provided at each of the two ends of the connecting rod 131. An annular recess 1311 recessed circumferentially around the connecting rod 131 is formed in each connection section a. Each of the connection slots 122 has an opening that opens at an upper side thereof. A rib ridge 1221 protrudes upwardly from a bottom surface of each of the connection slots 122. When the connection section a of each of the two ends of the connecting rod 131 is inserted into a corresponding connection slot 122, the annular recess 1311 of the connection section a receives the rib ridge 1221 of the corresponding connection slot 122, thereby removably connecting the connecting rod 131 with the connection slots 122. In this embodiment, each of the connection slots 122 is a U-shaped slot that has the opening that opens upwardly at the upper side thereof, and each of the connection slots 122 has a shape that matches a shape of a corresponding connection section a of the connecting rod 131.

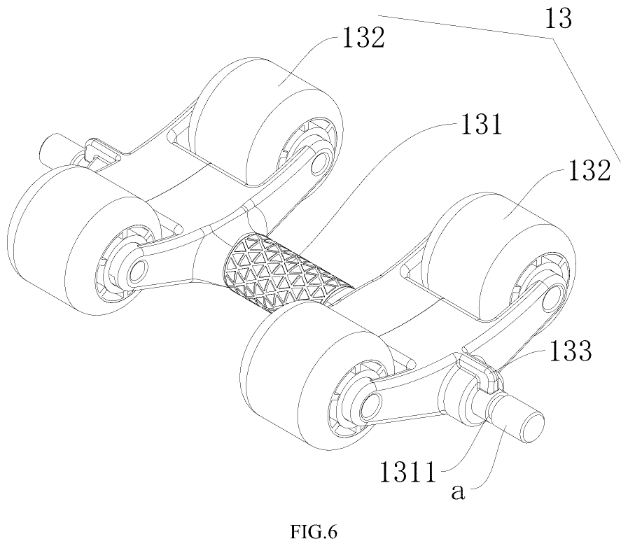

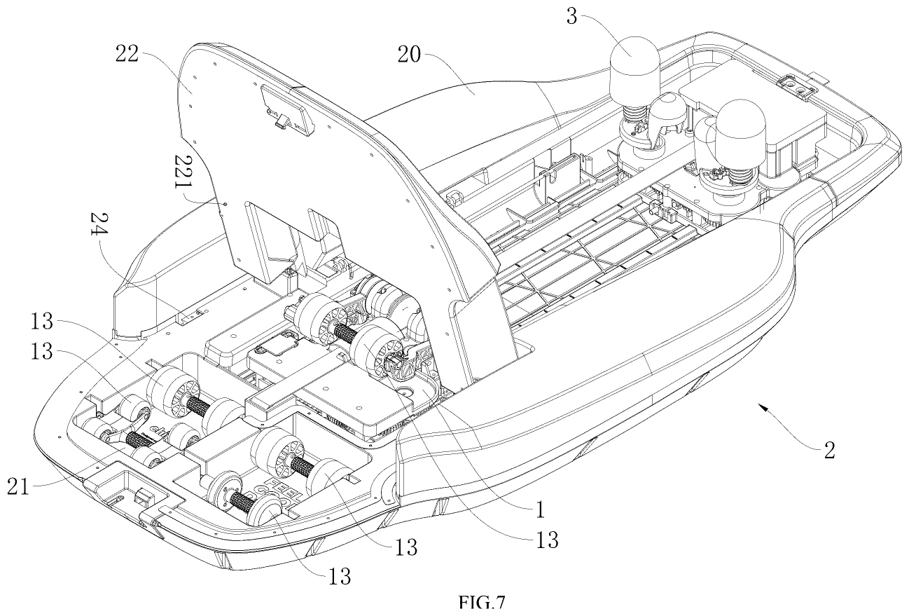

As shown in FIG. 5, said at least one massage member 132 of the massage head assembly 13 comprises two symmetric massage members 132 connected to the connecting rod 131. In this embodiment, each massage member 132 is a single massage head. FIG. 6 shows another embodiment of the massage head assembly 13, in which two symmetric massage members 132 are provided on the two ends of the connecting rod 131 respectively. In the embodiment of FIG. 6, each massage member 132 comprises two rotatable massage heads to provide different massage effects. Each massage member 132 is located on the connecting rod 131 at a position facing to an inner end of a corresponding connection section a (the inner end defined as an end of the corresponding connection section a which is more proximal to a middle point of a length of the connection rod 131). Protrusions 133 are also formed on the two ends of the connecting rod 131 respectively, wherein each protrusion 133 is located on a corresponding end of the connecting rod 131 at a position on the connecting rod 131 between the annular recess 1311 on the corresponding end of the connecting rod 131 and a corresponding massage member 132 on the corresponding end of the connecting rod 131. When the connection section a at each of the two ends of the connecting rod 131 fits into a corresponding connection slot 122, each protrusion 133 can be limited within the opening of the corresponding connection slot 122, thus serves to limit relative positioning of the two rotatable massage heads of each massage member 132.

Further, as shown in FIG. 2, at least one of the connection slots 122 of a corresponding one of the two massage arms 121 is provided with a first sensor 123 configured to sense the massage head assembly 13. The first sensor 123 generates a first sensing signal to signify presence of the massage head assembly 13 when the connecting rod 131 is connected to said at least one of the connection slots 122, so that the first massage core mechanism operates only when the massage head assembly 13 is present, thereby preventing idle operation of the first massage core mechanism.

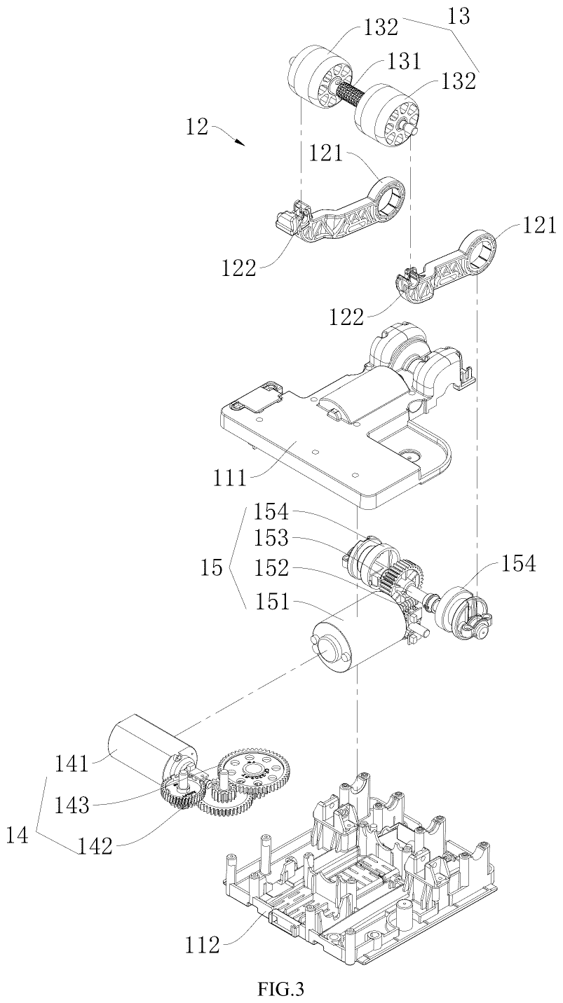

In this embodiment, with reference to FIG. 3 or 8, the housing 11 is divided into an upper housing 111 and a lower housing 112; the first drive device 15 is disposed between the upper housing 111 and the lower housing 112. The first drive device 15 comprises a first massage motor 151, a first transmission gear set 152 driven by the first massage motor 151, wherein the first transmission gear set 152 comprises a worm wheel and transmission gears, a rotating shaft 153 driven to be rotated by the first transmission gear set 152, and two eccentric wheels 154 connected on two ends of the first rotating shaft 153 respectively. The rear ends of the two massage arms 121 sleeve the two eccentric wheels 154 respectively. Through eccentric rotation of the two eccentric wheels 154, the two massage arms 121 are driven to synchronously oscillate reciprocally, thereby driving the massage head assembly 13 to perform massage.

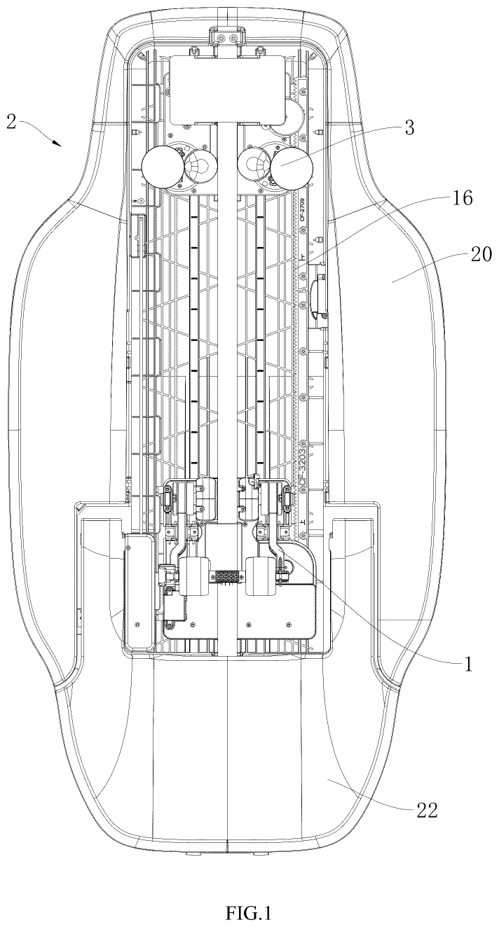

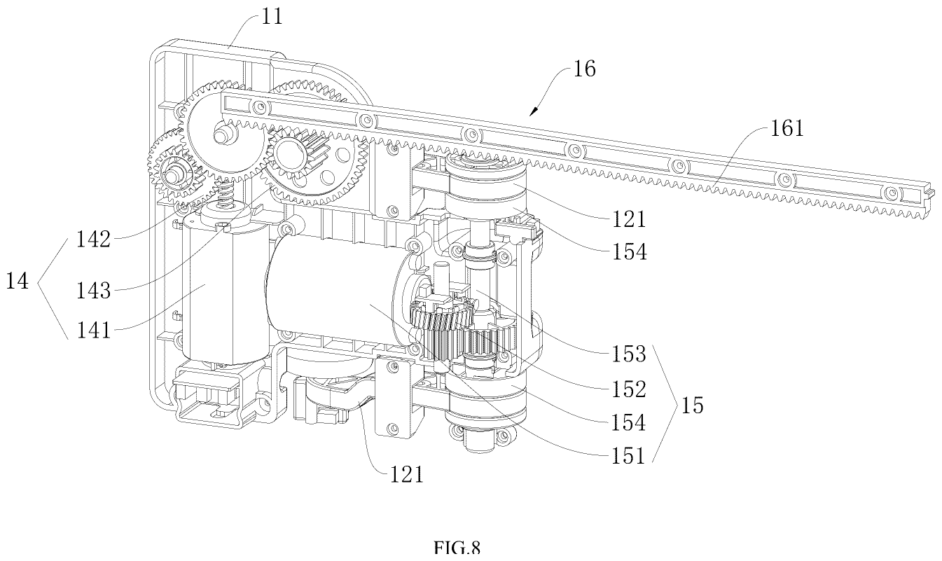

The present invention also discloses a massage apparatus 2. As shown in FIGS. 1 and 7, the massage apparatus is a massage bed comprising a back plate 20. The above-described first massage core mechanism 1 is mounted on the back plate 20. A traveling mechanism 16 that allows the first massage core mechanism 1 to be movable thereon is provided on the back plate 20. The traveling mechanism 16 comprises a rack 161 disposed on the back plate 20, preferably located on one side of the back plate 20. The first massage core mechanism 1 further comprises a second drive device 14 for driving the first massage core mechanism 1 to travel reciprocally on the traveling mechanism 16. As shown in FIG. 3 or 8, the second drive device 14 comprises a first traveling motor 141, a first traveling transmission gear set 142 driven by the first traveling motor 141, wherein the first traveling transmission gear set 142 comprises a worm wheel and transmission gears, and a first traveling gear 143 meshed with the transmission gears and the rack 161 so that the first massage core mechanism 1 is driven to move on the rack 161 along the back plate 20.

In this embodiment, a second massage core mechanism 3 is further provided on the back plate 20 to travel reciprocally on the traveling mechanism 16. The first massage core mechanism 1 may serve as a back massage core mechanism, and the second massage core mechanism 3 may serve as a shoulder-neck massage core mechanism. The second massage core mechanism 3 may also reciprocate along the traveling mechanism 16. The coordinated control between the first massage core mechanism 1 and the second massage core mechanism 3 is not described in detail here. The massage apparatus 2 may be provided with a control system (not shown in the figures). The first massage core mechanism 1 and the second massage core mechanism 3 are electrically connected to the control system and operate under the control of the control system (this is well known technology and will not described in detail herein).

A placement slot 21 is also provided on the back plate 20, and a flip cover 22 is provided to open and close the placement slot 21. A plurality of massage head assemblies 13 can be placed in the placement slot 21, and the placement slot 21 may be partitioned into a plurality of placement regions to accommodate the plurality of massage head assemblies 13. The massage members of the plurality of massage head assemblies 13 may be in different shapes (for example, the different massage head assemblies as described above and shown in FIGS. 5 and 6). Because each of all of the plurality of massage head assemblies 13 has said connecting rod 131 with said at least one massage member 132 connected thereto, and the connecting rod 131 can be embedded and fixed into the connection slots 122, all the plurality of massage head assemblies 13 can be detachably connected to and positioned between the front ends of the two massage arms 121. When it is required to replace a massage head assembly 13, the connecting rod 131 is simply removed from the connection slots 122, and then another massage head assembly 13 is taken from the placement slot 21 and installed into the connection slots 122 at the front ends of the two massage arms 121. The operation is simple and quick. The removed massage head assembly 13 or spare massage head assemblies 13 can be stored in the placement slot 21 of the back plate 20 and can be taken out for replacement when needed.

As shown in FIG. 7, a first Hall sensor 24 is provided on the back plate 20 on one side of the placement slot 21. A first magnet 221 corresponding to the first Hall sensor 24 is mounted on a rear surface of the flip cover 22 facing the placement slot 21 for sensing the first Hall sensor 24. When the flip cover 22 is opened, the first Hall sensor 24 detects that the first magnet 221 is no longer present and can output a corresponding sixth sensing signal (a stop trigger signal) to the control system of the massage apparatus 2, whereupon operation of the entire massage apparatus immediately stops. When the flip cover 22 is closed, the massage apparatus can be restarted by pressing the corresponding control switch to resume operation, thereby ensuring safe use and operation of the massage apparatus 2.

It should be understood that, the first massage core mechanism 1 of the present invention can be applied in massage beds, massage chair backs, and other massage apparatus. For example, in the embodiment as shown by the present invention, the first massage core mechanism 1 is applied in a massage bed to serve as a back massage assembly to relax the waist and back. Additional massage core mechanisms can be installed in the massage apparatus as required. In the first massage core mechanism 1 of the present invention, the massage head assembly 13 is detachably connected to the two massage arms 121. When a massage head assembly 13 does not suit a user, or when it is damaged and requires repair or replacement, it can be removed and replaced with another massage head assembly 13. Furthermore, a placement slot 21 for storing spare massage head assemblies 13 can be provided on the back plate 20 of the massage apparatus to facilitate replacement and storage of different massage head assemblies by the user. Therefore, the first massage core mechanism 1 of the present invention provides customized selection of massage head assemblies 13 for users, improving comfort and flexibility, while reducing maintenance costs and difficulty; when one massage head assembly 13 is damaged, there is no need to repair or replace the entire massage assembly 12.

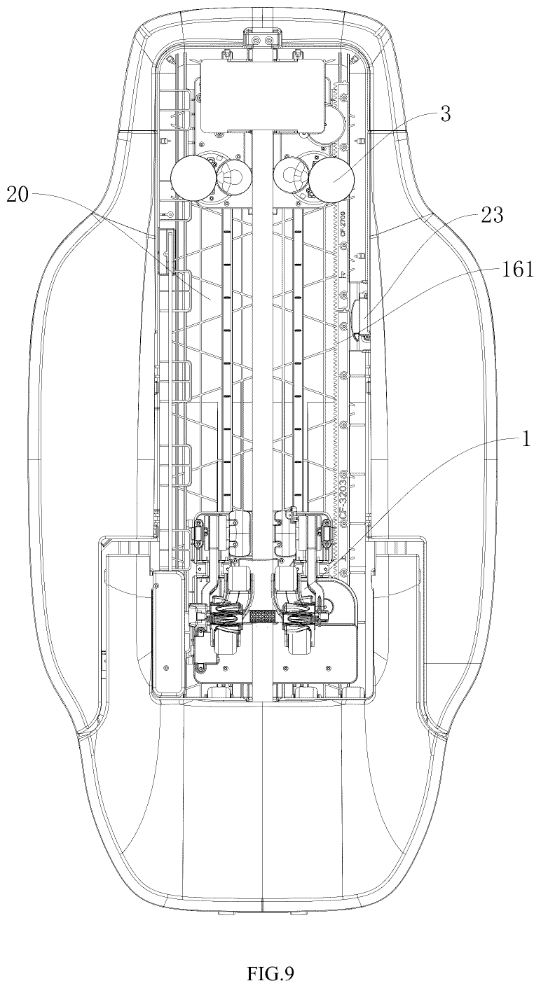

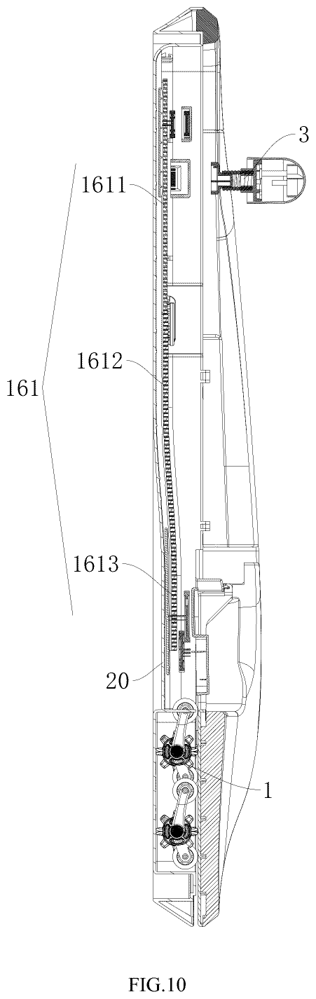

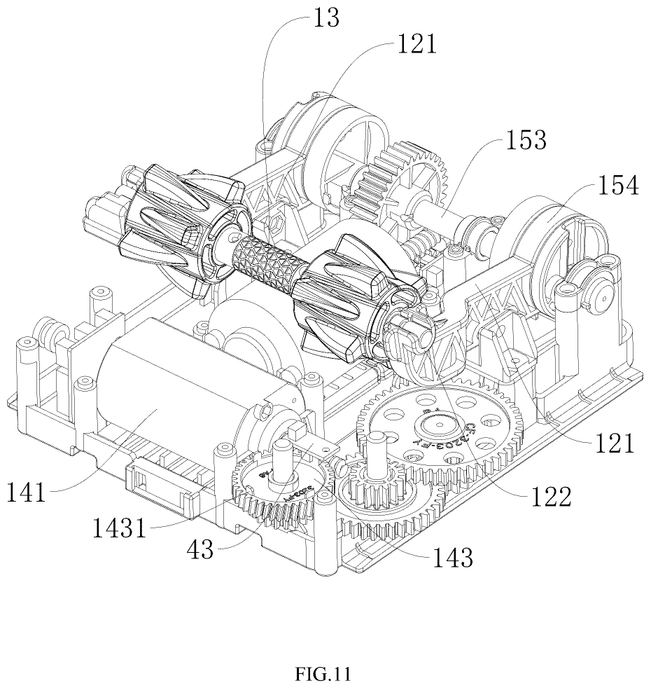

The back plate 20 may be curved to conform to a curvature of human back. As shown in FIGS. 9 and 10, the rack 161 may also be curved to follow a curved shape of the back plate. As shown with reference to the orientation shown in FIG. 10, the rack 161 comprises, from top to bottom, a starting section 1611 corresponding to the neck, a middle section 1612 corresponding to the back, and an outward convex arc section 1613 corresponding to the waist convex towards a user at the user's lumbar region. Compared with a flat planar back plate, a curved back plate allows the massage core mechanisms thereon to better fit the curvature of the human back during movement.

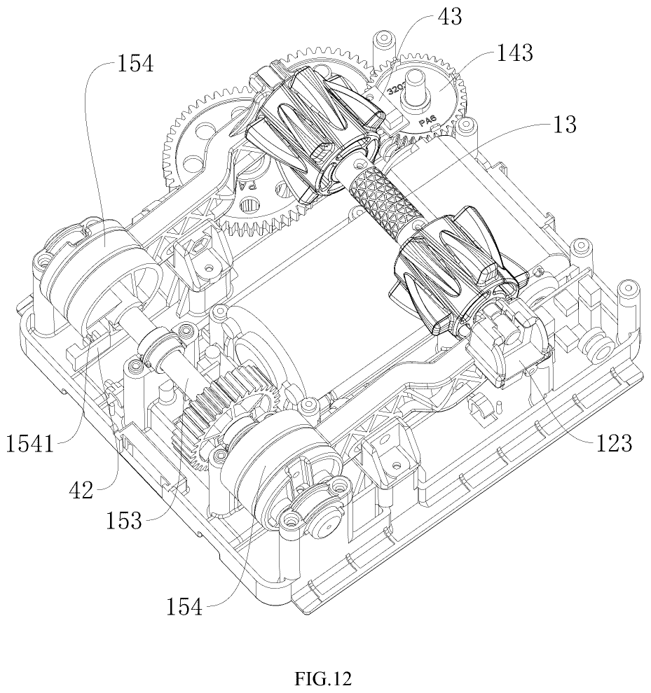

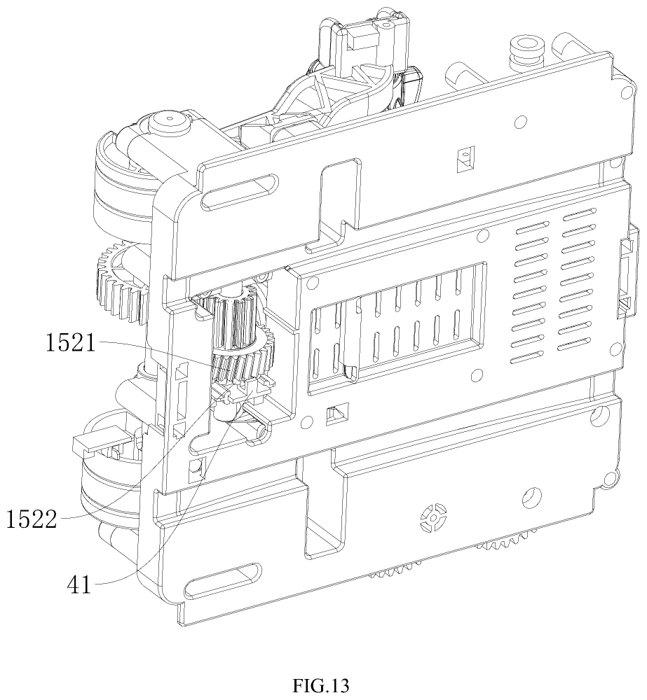

With reference to FIGS. 11 to 15, another embodiment of the present invention is described. On the basis of the previous embodiment, this embodiment of adds three more sensors so that when the first massage core mechanism 1 travels along the user's back, a distance of said at least one massage member (typically a massage head) of the massage head assembly 13 of the first massage core mechanism 1 with respect to a surface of the massage apparatus in contact with the user can be adjusted to follow the back and waist curvature (variation of this distance usually corresponds to variation of pressure force applied for massaging), enabling said at least one massage member to directly conform to the natural curvature of the human back for continuous kneading massage. Specifically, with reference to FIGS. 11 to 13, the first transmission gear set 152 comprises a first worm wheel 1521 connected to a worm. A worm wheel sensor 41 is provided at an outer side of the first worm wheel 1521. A plurality of worm wheel sensing elements 1522 are arranged on the first worm wheel 1521 along a circumferential direction thereof. When the first worm wheel 1521 rotates, the worm wheel sensor 41 detects the plurality of worm wheel sensing elements 1522 and generates a second sensing signal. An eccentric wheel sensing element 1541 is provided on one of the two eccentric wheels 154, and an eccentric wheel sensor 42 is provided on one side of said one of the two eccentric wheels 154. The eccentric wheel sensor 42 detects the eccentric wheel sensing element 1541 when said one of the two eccentric wheels 154 drives the corresponding one of the two massage arms 121 to oscillate to a lowest point, i.e., whereupon the front end of the corresponding massage arm 121 and the connecting rod 131 drive the corresponding massage member 132 to a lowest point (a minimum height of the massage member), and outputs a third sensing signal. A traveling gear sensor 43 is provided on an outer side of the first traveling gear 143. A plurality of traveling gear sensing elements 1431 are arranged on the first traveling gear 143 along a circumferential direction thereof. When the first traveling gear 143 rotates, the traveling gear sensor 43 detects the plurality of traveling gear sensing elements 1431 and generates a fourth sensing signal.

The worm wheel sensor 41, the eccentric wheel sensor 42, and the traveling gear sensor 43 are grating (optical encoder) sensors, and the plurality of worm wheel sensing elements 1522, the eccentric wheel sensing element 1541, and the plurality of traveling gear sensing elements 1431 define grating detection points. The control system of the massage apparatus 2 may be operated together with a remote controller (not shown in the figures). The remote controller has selectable kneading modes and other massage modes, as well as options such as intensity selection (these are well known technologies and are not the focus of the present invention). The worm wheel sensor 41, the eccentric wheel sensor 42, and the traveling gear sensor 43 are electrically or communicatively connected to the control system.

Due to the worm wheel sensor 41, the eccentric wheel sensor 42, and the traveling gear sensor 43, when the first massage core mechanism 1 operates in the massage apparatus 2, the traveling gear sensor 43 can, via the plurality of traveling gear sensing elements 1431, sense a number of rotations of the first traveling gear 143 (with the gear transmission ratio predetermined), and send the sensing signal (the fourth sensing signal) to the control system of the massage apparatus 2. Based on the detected data, the control system can determine a traveling distance of the first massage core mechanism 1 on the rack 161 (calculated based on programmed logic of the control system, which is a known technology) and thereby identify a position of the first massage core mechanism 1. The eccentric wheel sensor 42, when having the eccentric wheel sensing element 1541 on said one of the two eccentric wheels 154 detected, determines a lowest oscillation point of the corresponding massage arm 121, whereby the connecting rod 131 at the front of the two massage arms 121 also drives said at least one massage member 132 to a lowest point (minimum height of said at least one massage member), and transmit the sensing signal (the third sensing signal) to the control system. In addition, the worm wheel sensor 41 can sense the plurality of worm wheel sensing elements 1522 on the first worm wheel 1521. During rotation of the first worm wheel 1521, the plurality of worm wheel sensing elements 1522 will be sequentially detected, and a number of the plurality of worm wheel sensing elements 1522 being detected during rotation of the first worm wheel 1521 correspond to a corresponding change of the distance of said at least one massage member with respect to the surface of the massage apparatus in contact with the user, thereby determining how far said at least one massage member is positioned with respect to the user (and thus how much pressure said at least one massage member applies).

Accordingly, when the first massage core mechanism 1 is selected (via the remote controller) to operate in the kneading mode, the first massage core mechanism 1 travels up and down in the massage apparatus 2, and said at least one massage member 132 applies kneading massage to the user's back and waist. First, a peak height of said at least one massage member 132 can be selected to obtain a desired massage intensity. The peak height being a desired closest distance of said at least one massage member 132 with respect to the surface of the massage apparatus in contact with the user. As explained above, the closer the distance, the higher the pressure force being applied and thus the higher the massage intensity. Specifically, a desired peak height can be selected via the remote controller. Because a plurality of worm wheel sensing elements 1522 are provided on the first worm wheel 1521, if three peak heights are set (for example, where there are nine worm wheel sensing elements 1522, the third, the sixth, and the ninth worm wheel sensing elements 1522 will define three peak heights respectively), the control system can be set to rotate the first worm wheel 1521 until after receiving from the eccentric wheel sensor 42 said third sensing signal indicating that said one of the eccentric wheels 154 has driven the corresponding massage arm 121 to the lowest point, after that, continue to rotate the first worm wheel 1521 to a desired worm wheel sensing element of said plurality of worm wheel sensing elements according to the desired peak height (e.g., to obtain a second peak height in case three peak heights are set (wherein the second peak height being higher than the first peak height, and lower than the third peak height), rotate until the sixth worm wheel sensing element is detected) to achieve the desired peak height of said at least one massage member 132. Thus, different peak heights of said at least one massage member 132 can be set according to different users' needs to give different massage intensities.

After the desired peak height of said at least one massage member 132 is determined, the kneading mode can be initiated. In this kneading mode, the first massage core mechanism 1 travels up and down along the rack 161 via the first traveling gear 143. To enable automatic adjustment to different intensities when the first massage core mechanism 1 moves from the back to the waist, when the traveling gear sensor 43 determines that the first massage core mechanism 1 reaches the waist, the first worm wheel 1521 is set to automatically start rotating to advance by a preset number of worm wheel sensing elements 1522 (as set by the control system), thus raising the peak height of said at least one massage member 132 so that, at the waist, said at least one massage member 132 is elevated (brought closer to the user) to adjust the intensity, thereby conforming to the curvature of the human back and avoiding insufficient massage force at the waist. As the first massage core mechanism 1 continues to travel, upon reaching the lower end of the waist and returning to the starting position of the waist, as determined by the traveling gear sensor 43 based on the number of rotations of the first traveling gear 143, the first worm wheel 1521 can (as per the commands from the control system) start to rotate reversely to lower the previously elevated massage member 132 back to the original peak height, thereby avoiding excessively elevated massage member 132 that would affect back kneading intensity during continued movement. Thereafter, the first massage core mechanism 1 maintains the previous peak height of the massage member 132 and continues kneading the back until it travels up to the neck and returns to the waist starting position again, whereupon the first worm wheel 1521 will automatically elevate the massage member 132 again. This cycle repeats until user stops the massage apparatus. Therefore, by means of the three sensors, the control system, and the remote controller, the peak height of said at least one massage member 132 can be adjusted to achieve different massage intensities during the kneading massage process by the first massage core mechanism 1. Specifically, said at least one massage member 132 can be automatically adjusted to different peak heights when traveling across different regions of the back, better conforming to the curvature of the human back and providing a more comfortable massage experience.

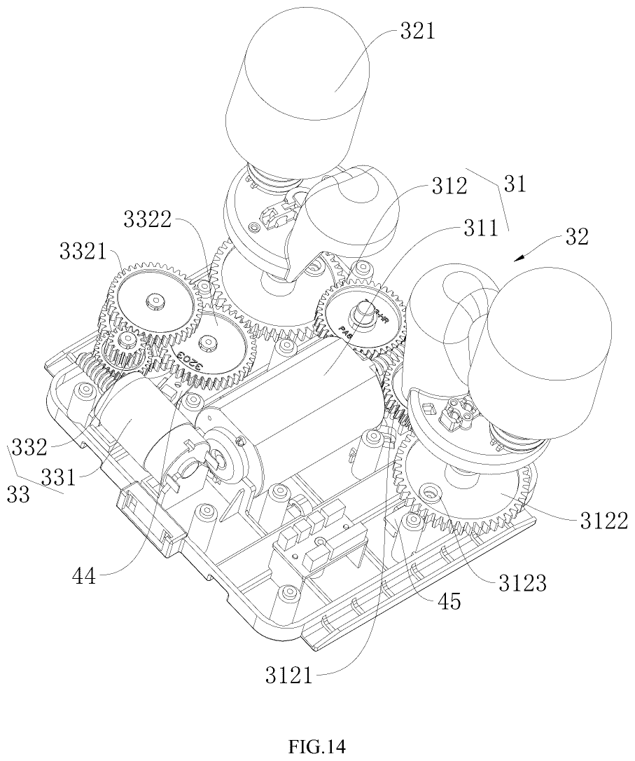

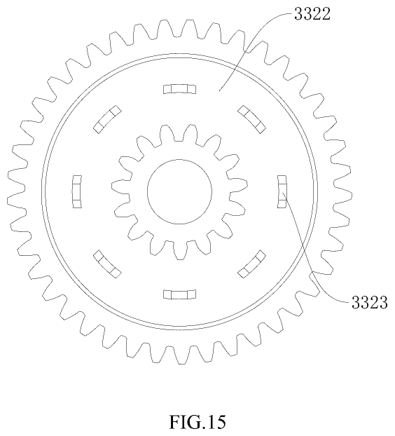

With reference to FIGS. 14 and 15, in the massage apparatus 2, the second massage core mechanism 3 can serve as a neck massage core mechanism. The second massage core mechanism 3 comprises a third drive device 31, a second massage head assembly 32, and a fourth drive device 33. The third drive device 31 comprises a second massage motor 311, and a second transmission gear set 312 driven by the second massage motor 311. The fourth drive device 33 comprises a second traveling motor 331, and a second traveling transmission gear set 332 driven by the second traveling motor 331. The second traveling transmission gear set 332 is provided with a second traveling gear 3321 meshed with the rack 161, so that the second massage core mechanism 3 can also move on the rack 161 along the back plate 20 to perform neck massage. A lower-limit travel switch 23 (shown in FIG. 9) is further provided on the back plate 20 to limit further downward movement of the second massage core mechanism 3. The lower-limit travel switch 23 is provided on one side of the rack 161. Because a stroke of the second massage core mechanism 3 configured for neck massage only is short, the lower-limit travel switch 23 prevents the second massage core mechanism 3 from interfering with the first massage core mechanism 1 traveling on the back plate 20.

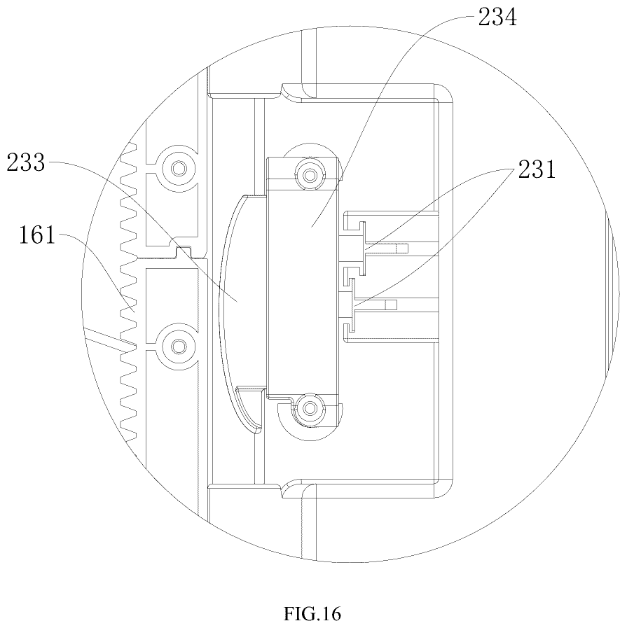

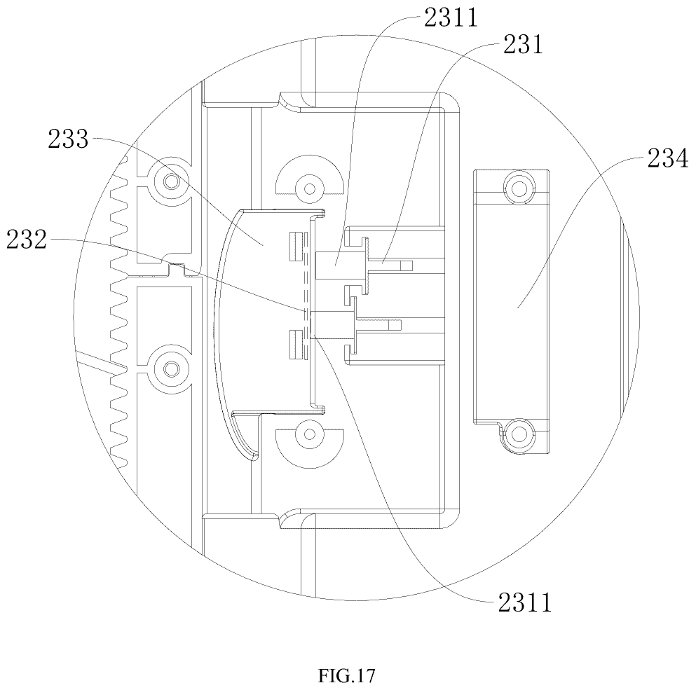

With reference to FIG. 16 and FIG. 17, in this embodiment, the lower-limit travel switch 23 may comprise two spring switches 231 having two springs 2311 respectively, a metal contact piece 232, a trigger block 233, and a limiting block 234. The metal contact piece 232 is mounted on the trigger block 233 and faces towards the two springs 2311 of the two spring switches 231. The two spring switches 231 are arranged parallel one above another and staggered with respect to each other (i.e. as shown in FIG. 17, the two spring switches 231 do not align with a same column). A lower one of the two spring switches 231 is positioned closer to the metal contact piece 232 on the trigger block 233, causing a corresponding spring 2311 of said lower one of the two spring switches 231, when not being compressed, to be positioned nearer to the metal contact piece 232 than a corresponding spring 2311 of an upper one of the two spring switches 231. The trigger block 233 is accommodated in the limiting block 234, and the limiting block 234 is fixed on the back plate 20 and located on an outer side of the rack 161.

When the second massage core mechanism 3 travels to a position that reaches the lower-limit travel switch 23, a housing of the second massage core mechanism 3 (a protrusion may be provided on the housing) touches the trigger block 233 of the lower-limit travel switch 23 and gradually pushes the trigger block outward. The outwardly pushed trigger block 233 will compress the corresponding spring 2311 of said lower one of the two spring switches 231, causing the metal contact piece 232 to contact the corresponding spring 2311 of said upper one of the two spring switches 231. After both the two springs 2311 are electrically connected by the metal contact piece 232, an electrical signal is generated. The electrical signal is then transmitted to the control system, which controls the second traveling motor 331 to stop operating, preventing the second massage core mechanism 3 from traveling further downward.

In this embodiment, the second traveling transmission gear set 332 is also provided with a transmission gear 3322 driving the second traveling gear 3321 to rotate. A transmission gear sensor 44 is provided on an outer side of the transmission gear 3322. A plurality of transmission gear sensing elements 3323 are circumferentially arranged on a bottom surface of the transmission gear 3322 (as shown in FIG. 15). When the second traveling gear 3321 rotates, the transmission gear sensor 44 detects the plurality of transmission gear sensing elements 3323 and generates a fifth sensing signal. The transmission gear sensor 44 is a grating (optical encoder) sensor. The transmission gear sensor 44 can detect a number of rotations of the transmission gear 3322 and transmit the sensing signal (the fifth sensing signal) to the control system of the massage apparatus. Based on the detected data, the control system can determine a traveling distance of the second massage core mechanism 3 on the rack 161, thereby achieving precise positioning of the second massage core mechanism 3 and enabling customized memory of different neck positions (and thus different positions of the second massage core mechanism 3) for different users of different heights.

Additionally, the second transmission gear set 312 comprises two kneading transmission gears 3121. The two kneading transmission gears 3121 are driven via a worm on the second massage motor 311. Kneading gears 3122 are respectively connected to the two kneading transmission gears 3121 respectively. Neck massage heads 321 are eccentrically provided on the kneading gears 3122 respectively. The neck massage heads 321 can form the second massage head assembly 32 together with other massage heads. An anti-clamping Hall sensor 45 is provided on an outer side of one of the kneading gears 3122. A kneading gear magnet 3123 is provided on said one of the kneading gears 3122. When the neck massage head 321 on said one of the kneading gears 3122 rotates to an outer side (preferably at a position where the two neck massage heads 321 are most distal from each other), the kneading gear magnet 3123 is sensed by the anti-clamping Hall sensor 45. If no sensing signal is received, the second massage motor 311 continues to rotate until the sensing signal is received, then the second massage motor 311 stops. By means of the anti-clamping Hall sensor 45, the neck massage heads 321 are prevented from suddenly stopping when the neck massage heads 321 are at intermediate positions where the user's neck muscles may be clamped by the neck massage heads 321. This ensures that, when the second massage core mechanism is powered off, the two neck massage heads 321 are most distal from each other to facilitate use next time.

The above embodiments and drawings do not limit the form and style of the present invention. Any appropriate changes or modifications made by those of ordinary skill in the art should be considered as falling within the scope of the present invention.

1. A first massage core mechanism, comprising a housing, a first drive device, and a massage assembly; the massage assembly comprises two massage arms parallel to each other; a massage head assembly is detachably connected to and positioned between front ends of the two massage arms; rear ends of the two massage arms are mounted on the first drive device; the two massage arms are configured to perform reciprocating motion when the rear ends of the two massage arms are driven by the first drive device; the massage head assembly comprises a connecting rod and at least one massage member connected to the connecting rod; the front ends of the two massage arms are provided with connection slots respectively; when the massage head assembly is connected to the two massage arms, two ends of the connecting rod are embedded and fixed in the connection slots respectively.

2. The first massage core mechanism of claim 1, wherein a connection section is provided at each of the two ends of the connecting rod; an annular recess recessed circumferentially around the connecting rod is formed in each connection section; each of the connection slots has an opening that opens at an upper side thereof; a rib ridge protrudes upwardly from a bottom surface of each of the connection slots; when the connection section of each of the two ends of the connecting rod is inserted into a corresponding connection slot, the annular recess of the connection section receives the rib ridge of the corresponding connection slot.

3. The first massage core mechanism of claim 2, wherein each of the connection slots is a U-shaped slot that has the opening that opens upwardly at the upper side thereof, and each of the connection slots has a shape that matches a shape of a corresponding connection section of the connecting rod.

4. The first massage core mechanism of claim 2, wherein said at least one massage member of the massage head assembly comprises two symmetric massage members connected to the connecting rod; each of the two symmetric massage member is located on the connecting rod at a position facing to an inner end of a corresponding connection section, wherein the inner end of the corresponding connection section is defined as an end of the corresponding connection section which is more proximal to a middle point of a length of the connection rod than another opposite end of the corresponding connection section; protrusions are also formed on the two ends of the connecting rod respectively, wherein each of the protrusions is located on a corresponding one of the two ends of the connecting rod at a position on the connecting rod between the annular recess on the corresponding one of the two ends of the connecting rod and a corresponding one of the two symmetric massage members on the corresponding one of the two ends of the connecting rod; when the connection section at each of the two ends of the connecting rod fits into a corresponding connection slot, each of the protrusions is limited within the opening of the corresponding connection slot.

5. The first massage core mechanism of claim 1, wherein at least one of the connection slots of a corresponding one of the two massage arms is provided with a first sensor configured to sense the massage head assembly; the first sensor generates a first sensing signal to signify presence of the massage head assembly when the connecting rod is connected to said at least one of the connection slots.

6. The first massage core mechanism of claim 1, wherein the first drive device comprises a first massage motor, a first transmission gear set driven by the first massage motor, a rotating shaft driven to be rotated by the first transmission gear set, and two eccentric wheels connected on two ends of the first rotating shaft respectively; the rear ends of the two massage arms sleeve the two eccentric wheels respectively.

7. A massage apparatus, comprising a back plate; the first massage core mechanism according to claim 1 is mounted on the back plate; a traveling mechanism that allows the first massage core mechanism to be movable thereon is provided on the back plate; the traveling mechanism comprises a rack disposed on the back plate; the first massage core mechanism further comprises a second drive device for driving the first massage core mechanism to travel reciprocally on the traveling mechanism.

8. The massage apparatus of claim 7, wherein a placement slot is also provided on the back plate, and a flip cover is provided to open and close the placement slot; the placement slot is configured to accommodate a plurality of spare massage head assemblies each being said massage head assembly; massage members of the plurality of spare massage head assemblies are in different shapes; each of all the plurality of spare massage head assemblies is capable of being detachably connected to and positioned between the front ends of the two massage arms.

9. The massage apparatus of claim 8, wherein a first Hall sensor is provided on the back plate on one side of the placement slot; a first magnet corresponding to the first Hall sensor is mounted on a rear surface of the flip cover facing the placement slot for sensing the first Hall sensor when the flip cover closes the placement slot.

10. The massage apparatus of claim 7, wherein the second drive device comprises a first traveling motor, a first traveling transmission gear set driven by the first traveling motor, and a first traveling gear meshed with the rack so that the first massage core mechanism is driven to move on the rack along the back plate.

11. The massage apparatus of claim 10, wherein the first drive device comprises a first massage motor, a first transmission gear set driven by the first massage motor, a rotating shaft driven to be rotated by the first transmission gear set, and two eccentric wheels connected on two ends of the first rotating shaft respectively; the rear ends of the two massage arms sleeve the two eccentric wheels respectively; the first transmission gear set comprises a first worm wheel; a worm wheel sensor is provided at an outer side of the first worm wheel; a plurality of worm wheel sensing elements are arranged on the first worm wheel along a circumferential direction thereof; when the first worm wheel rotates, the worm wheel sensor detects the plurality of worm wheel sensing elements and generates a second sensing signal; a eccentric wheel sensing element is provided on one of the two eccentric wheels, and a eccentric wheel sensor is provided on one side of said one of the two eccentric wheels; the eccentric wheel sensor detects the eccentric wheel sensing element and outputs a third sensing signal when said one of the two eccentric wheels drives a corresponding one of the two massage arms to oscillate to a lowest point; a traveling gear sensor is provided on an outer side of the first traveling gear; a plurality of traveling gear sensing elements are arranged on the first traveling gear along a circumferential direction thereof; when the first traveling gear rotates, the traveling gear sensor detects the plurality of traveling gear sensing elements and generates a fourth sensing signal.

12. The massage apparatus of claim 11, wherein the worm wheel sensor, the eccentric wheel sensor, and the traveling gear sensor are grating sensors, and the plurality of worm wheel sensing elements, the eccentric wheel sensing element, and the plurality of traveling gear sensing elements define grating detection points.

13. The massage apparatus of claim 7, wherein the back plate is curved to conform to a curvature of a human back; the rack is also curved to follow a curved shape of the back plate; the rack comprises, from top to bottom, a starting section corresponding to a neck, a middle section corresponding to a back, and an outward convex arc section corresponding to a waist.

14. The massage apparatus of claim 11, wherein a second massage core mechanism is further provided on the back plate capable of travelling reciprocally on the traveling mechanism.

15. The massage apparatus of claim 14, wherein the second massage core mechanism comprises a third drive device, a second massage head assembly, and a fourth drive device; the third drive device comprises a second massage motor, and a second transmission gear set driven by the second massage motor; the fourth drive device comprises a second traveling motor, and a second traveling transmission gear set driven by the second traveling motor; the second traveling transmission gear set is provided with a second traveling gear, so that the second massage core mechanism is capable to move on the rack along the back plate; a lower-limit travel switch is further provided on the back plate to limit downward movement of the second massage core mechanism.

16. The massage apparatus of claim 15, wherein the second traveling transmission gear set is also provided with a transmission gear driving the second traveling gear to rotate; a transmission gear sensor is provided on an outer side of the transmission gear; a plurality of transmission gear sensing elements are circumferentially arranged on a bottom surface of the transmission gear; when the second traveling gear rotates, the transmission gear sensor detects the plurality of transmission gear sensing elements and generates a fifth sensing signal.

17. The massage apparatus of claim 15, wherein the second transmission gear set comprises two kneading transmission gears; kneading gears are connected to the two kneading transmission gears respectively; neck massage heads are eccentrically provided on the kneading gears respectively; a anti-clamping Hall sensor is provided on an outer side of one of the kneading gears; a kneading gear magnet is provided on said one of the kneading gears; when the neck massage head on said one of the kneading gears rotates to an outer side, the kneading gear magnet is sensed by the anti-clamping Hall sensor.
